(19) United States
(12) Patent Application Publication
(10) Pub. No.: US 2025/0285792 A1
(43) Pub. Date: Sep. 11, 2025

(54) POWER STAGE COOLED TRANSFORMER WITH VERTICAL OFFSET

(71) Applicant: Infineon Technologies Austria AG, Villach (AT)

(72) Inventors: Darryl TSCHIRHART, Newmarket (CA); Luca PELUSO, Villach (AT); Jens EJURY, Fremont, CA (US); Surendhar SOMASUNDARAM, Santa Clara, CA (US)

(21) Appl. No.: 18/596,275

(22) Filed: Mar. 5, 2024

(51) Int. Cl. H01F 5/02; H01F 5/04; H01F 30/12

(52) U.S. Cl. CPC H01F 5/02; H01F 5/04; H01F 30/12

(57) ABSTRACT

One or more structures and/or methods are provided. According to some embodiments, a transformer includes a substrate, a first winding having a first foot connected to the substrate, a first leg extending vertically from the first foot, a second foot connected to the substrate, a second leg extending vertically from the second foot, and a third leg extending parallel to the substrate to connect the first leg and the second leg, a second winding having a third foot connected to the substrate, a fourth leg extending vertically from the third foot, a fifth leg connected to the third leg and extending parallel to the substrate to at least partially overlap the third leg, a sixth leg extending vertically from the fifth leg away from the substrate, and a pad connected to the fourth leg, and a core enclosing at least a portion of the third leg and the fifth leg.

### BACKGROUND

In device packages, a footprint of a package is generally determined by the components mounted to a printed circuit board. A trans-inductor voltage regulator (TLVR) includes transformers with secondary windings connected in series. Power stage electronics for the TLVR include switches for selectively enabling the primary windings of the transformers to regulate the output voltage. The inductors of the primary windings and the secondary windings are loosely coupled and store energy during the voltage regulation operation.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

According to some embodiments, a transformer comprises a substrate, a first winding comprising a first foot connected to the substrate, a first leg extending vertically from the first foot, a second foot connected to the substrate, a second leg extending vertically from the second foot, and a third leg extending parallel to the substrate to connect the first leg and the second leg, a second winding comprising a third foot connected to the substrate, a fourth leg extending vertically from the third foot, a fifth leg connected to the third leg and extending parallel to the substrate to at least partially overlap the third leg, a sixth leg extending vertically from the fifth leg away from the substrate, and a pad connected to the fourth leg, and a core enclosing at least a portion of the third leg and the fifth leg.

According to some embodiments, a voltage regulator comprises a supply voltage terminal, a first circuit board, a first transformer comprising a first secondary winding connected to the first circuit board, a first primary winding comprising a first foot connected to the first circuit board, a first serpentine body connected to the first foot and at least partially overlapping the first secondary winding, and a first contact pad connected to the first serpentine body and vertically offset from a top surface of the first secondary winding in a direction away from the first circuit board, a second transformer comprising a second secondary winding connected to the first circuit board, a second primary winding comprising a second foot connected to the first circuit board, a second serpentine body connected to the second foot and at least partially overlapping the second secondary winding, and a second contact pad connected to the second serpentine body and vertically offset from a top surface of the second secondary winding in a direction away from the first circuit board, a second circuit board contacting the first contact pad and the second contact pad, an interconnect connecting the first secondary winding and the second secondary winding in series, an output terminal connected to the first primary winding and the second primary winding, and a power stage electronics package connected to the second circuit board and comprising a first switch connected between the supply voltage terminal and the first primary winding, and a second switch connected between the supply voltage terminal and the second primary winding.

According to some embodiments, a method comprises connecting a first winding to a first circuit board, the first winding comprising a first foot connected to the first circuit board, a first leg extending vertically from the first foot, a second foot connected to the first circuit board, a second leg extending vertically from the second foot, and a third leg connecting the first leg and the second leg, connecting a second winding to the first circuit board, the second winding comprising a third foot connected to the first circuit board, a fourth leg extending vertically from the third foot, a fifth leg connected to the third leg and extending parallel to the first circuit board to at least partially overlap the third leg, a sixth leg extending vertically from the fifth leg away from the first circuit board, and a pad connected to the fourth leg, connecting a second circuit board to the pad, and connecting a die comprises a power stage electronics package to the second circuit board.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

DESCRIPTION OF THE DRAWINGS

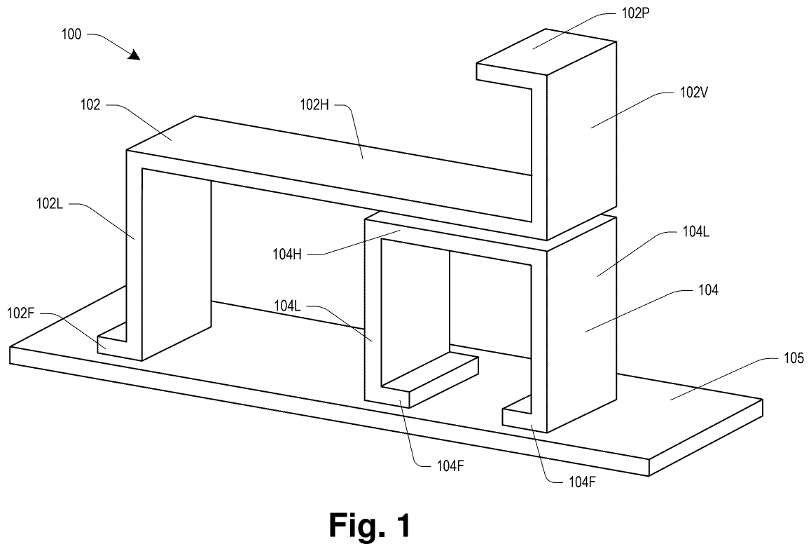

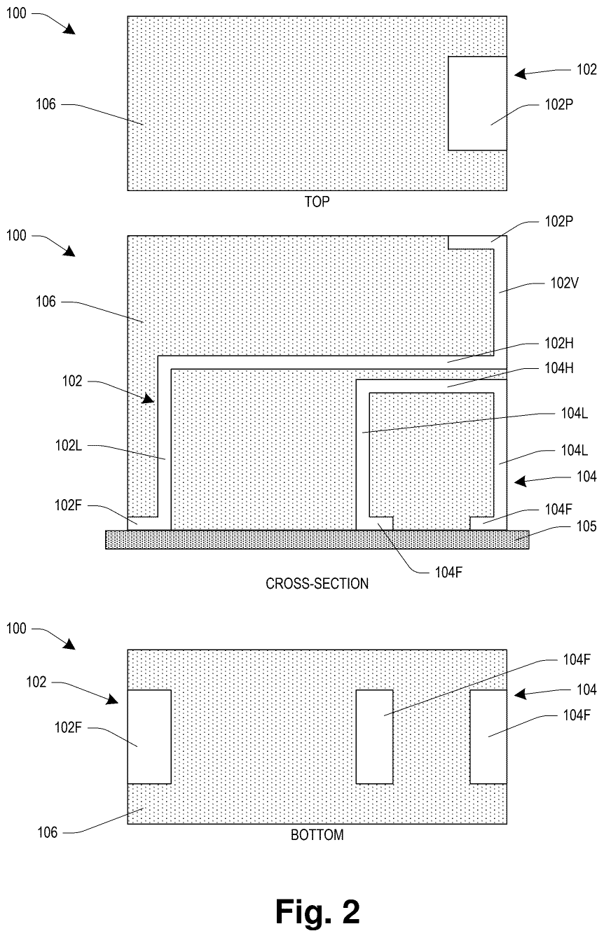

FIGS. 1 and 2 are views of a transformer, in accordance with some embodiments.

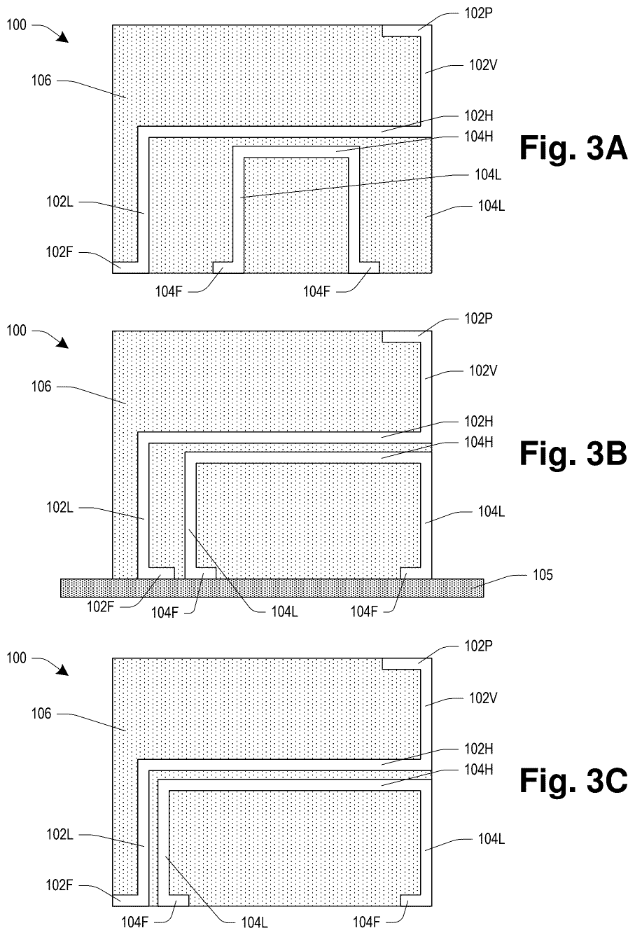

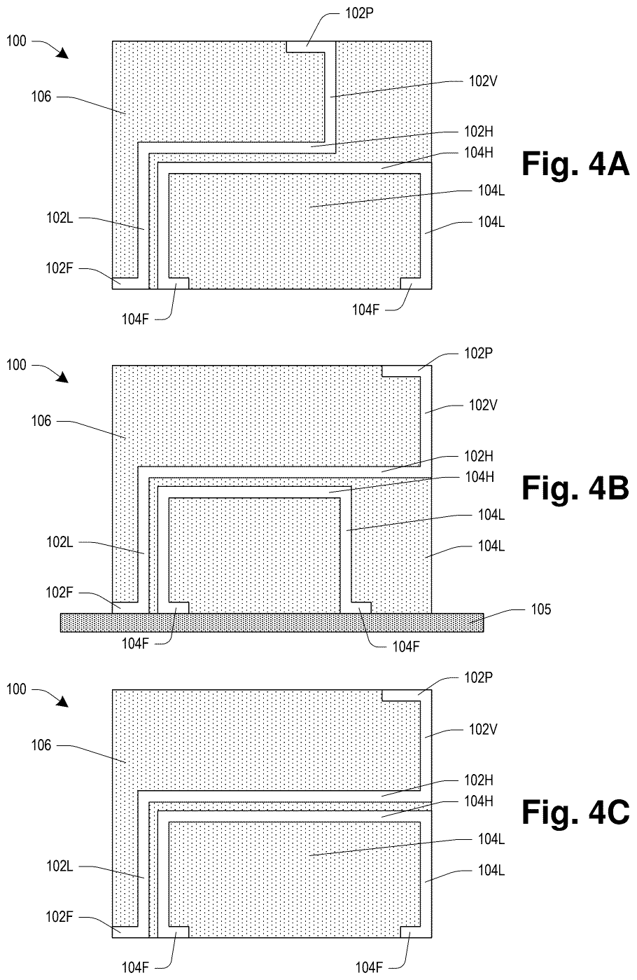

FIGS. 3A-3C and 4A-4C are embodiments of a transformer with differing couplings, in accordance with some embodiments.

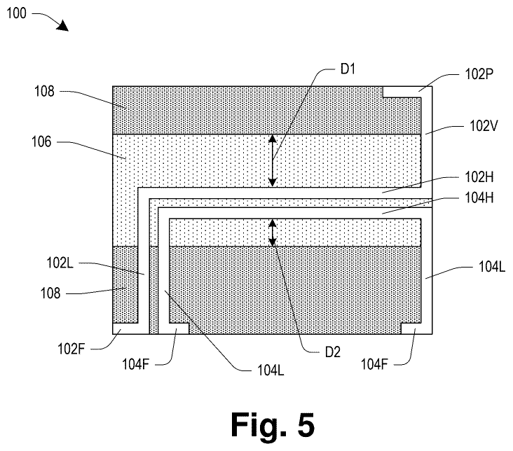

FIG. 5 is a view of a transformer illustrating coupling variation based on core placement, in accordance with some embodiments.

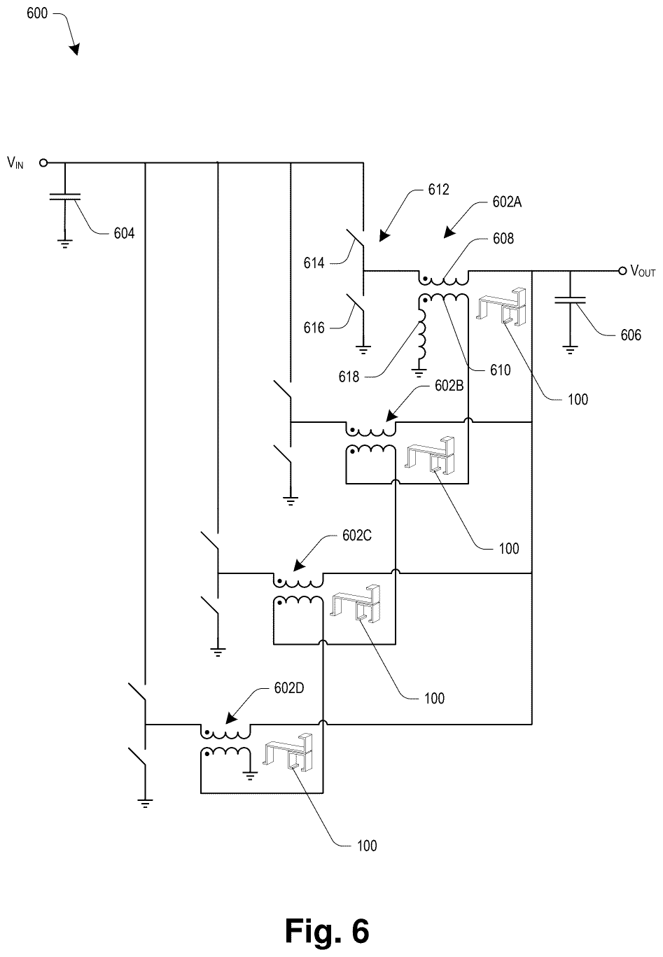

FIG. 6 is a circuit diagram of a trans-inductor voltage regulator (TLVR), in accordance with some embodiments.

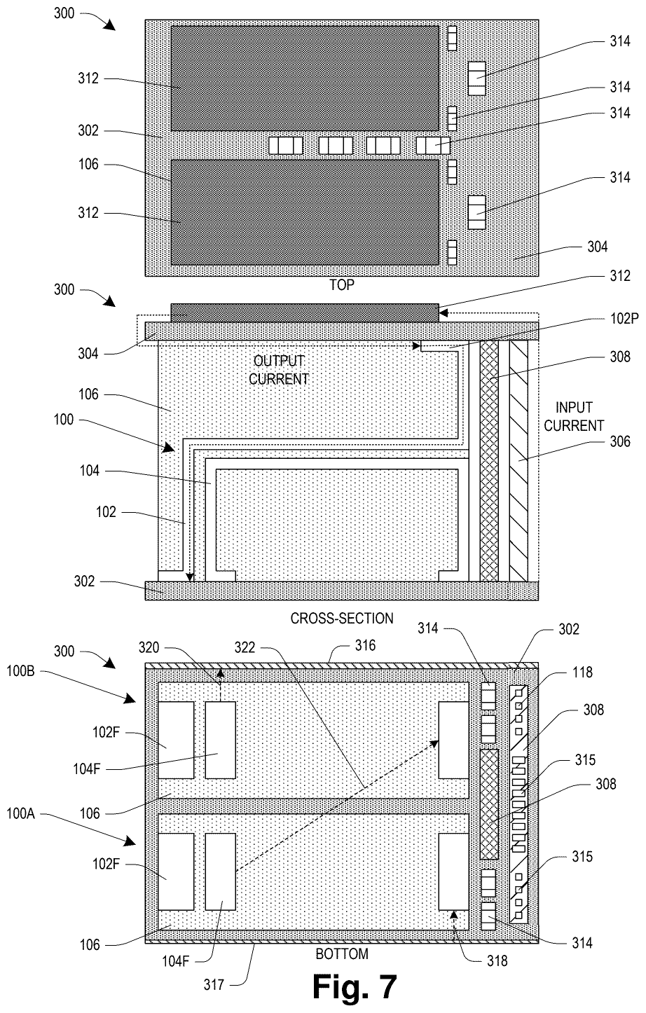

FIGS. 7-12 are diagrams illustrating power stage cooled transformers, in accordance with some embodiments.

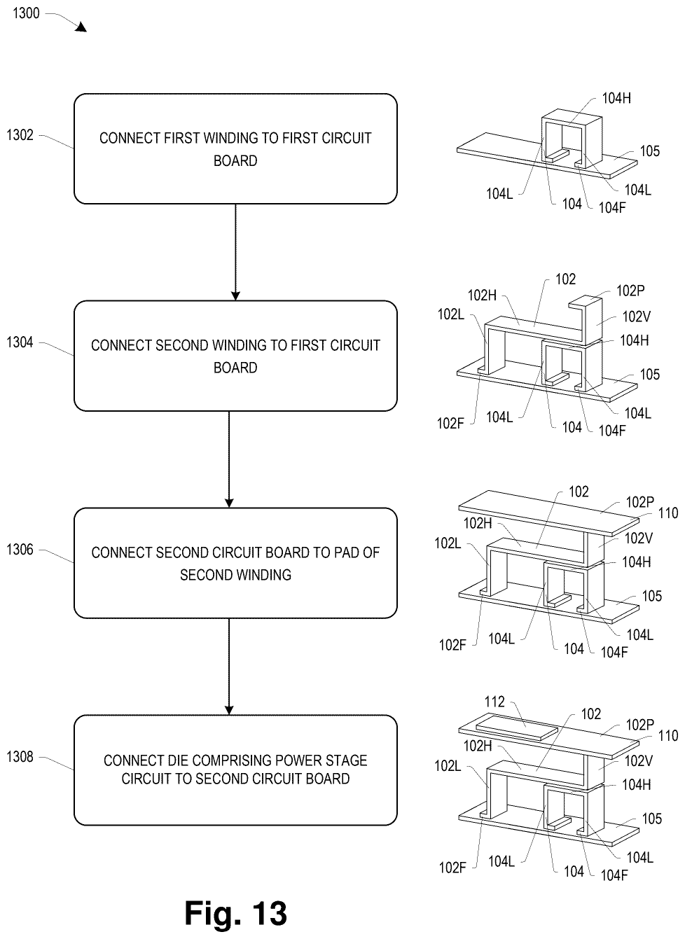

FIG. 13 is a flow diagram illustrating an example method for fabricating a power stage cooled transformer device, in accordance with some embodiments.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

It is to be understood that the following description of embodiments is not to be taken in a limiting sense. The scope of the present disclosure is not intended to be limited by the embodiments described hereinafter or by the drawings, which are taken to be illustrative only. The drawings are to be regarded as being schematic representations and elements illustrated in the drawings are not necessarily shown to scale. Rather, the various elements are represented such that their function and general purpose become apparent to a person skilled in the art.

All numerical values within the detailed description and the claims herein are modified by “about” or “approximately” the indicated value, and take into account experimental error and variations that would be expected by a person having ordinary skill in the art.

FIGS. 1 and 2 are views of a transformer 100, in accordance with some embodiments. FIG. 2 is an isometric view, and FIG. 2 illustrates a top view, a cross-section view, and a bottom view. The transformer 100 comprises a primary winding 102 and a secondary winding 104 at least partially enclosed by a core 106 (not shown in FIG. 1). The primary winding 102 and the secondary winding 104 may be mounted to a substrate 105, such as a circuit board.

In some embodiments, the primary winding 102 comprises a foot 102F, a leg 102L extending vertically from the foot 102F, a horizontal leg 102H at least partially overlapping the secondary winding 104, a leg 102V extending vertically from the horizontal leg 102H, and a contact pad 102P extending horizontally from the leg 102V. The leg 102V provides a vertical offset between the contact pad 102P and the secondary winding 104. The area of the contact pad 102P may be increased by ending the length to lower conduction losses. The primary winding 102 has a meandering shape. The meandering shape is similar to an S-shape, referred to herein as a square sigmoid shape.

In some embodiments, the secondary winding 104 comprises feet 104F, legs 104L extending vertically from the feet 104F, and a horizontal leg 104H connecting the legs 104L. In some embodiments, the secondary winding 104 has a box shape.

In some embodiments, the primary winding 102 and the secondary winding 104 are formed by stamping and bending planar pieces of metal, such as copper, hard copper, a copper alloy, or some other conductive material, to form the shapes illustrated herein. Accordingly, the primary winding 102 and the secondary winding 104 are referred to as planar windings. Although the primary winding 102 and the secondary winding 104 are illustrated as having square corners for ease of illustration, the bending process forms corners with radiuses. In some embodiments, the core 106 comprises a soft saturating magnetic material.

In FIG. 1, the foot 102F is illustrated as being outwardly facing and the feet 104F are illustrated as being inwardly facing. However, the feet 102F, 104F may be inwardly facing or outwardly facing and the feet 104F may not face the same way, depending on the particular geometry of the transformer 100.

The coupling between the primary winding 102 and the secondary winding 104 may vary depending on geometry. According to some embodiments, the coupling may be configured to provide a desired degree of leakage in the transformer 100. The transformer 100 may be used in a voltage regulator, not to transform an input voltage to an output voltage, but rather, the primary winding 102 and the secondary winding 104 may act as inductors for storing energy according to a switching scheme to convert an input voltage to an output voltage using an input capacitor and an output capacitor. In some embodiments, the voltage regulator may be a trans-inductor voltage regulator (TLVR).

FIGS. 3A-3C and 4A-4C are embodiments of the transformer 100 with differing degrees of coupling, in accordance with some embodiments. In FIGS. 3A-3C illustrate embodiments with different sized secondary windings 104 to affect the coupling of the transformer 100. The size of the secondary winding 104, and thus overlap between the windings 102, 104 and the coupling increases from FIG. 3A to FIG. 3C. In FIG. 3C, coupling is present between the horizontal legs 102H, 104H and the vertical legs 102L, 104L. Note that the orientation of the feet 102F, 104F may change depending on the spacing requirements.

FIGS. 4A-4C are embodiments of the transformer 100 with different sized primary windings 102 to affect the coupling of the transformer 100. The length of the horizontal leg 102H of the primary winding 102, and thus overlap between the horizontal legs 102H, 104H and the coupling increases from FIG. 4A to FIG. 4C. In FIG. 4C, coupling is present between the horizontal legs 102H, 104H and the vertical legs 102L, 104L. Note that the orientation of the feet 102F, 104F may change depending on the spacing requirements.

FIG. 5 is a view of the transformer 100 illustrating coupling variation based on placement of the core 106, in accordance with some embodiments. In the embodiment of FIG. 5, the core 106 does not completely encapsulate the primary winding 102 and the secondary winding 104. For example, a molding compound 108, such as epoxy resin, that does not significantly contribute to coupling between the primary winding 102 and the secondary winding 104 (compared to the core 106) may be provided below the core 106, above the core 106, or both. The distances D1 or D2 may be varied to affect the degree of coupling between the primary winding 102 and the secondary winding 104.

FIG. 6 is a circuit diagram of a trans-inductor voltage regulator (TLVR) 600 including the transformer 100, in accordance with some embodiments. In some embodiments, the TLVR 600 comprises multiple phases 602A, 602B, 602C, 602D connected between an input capacitor 604 at an input terminal, VIN, and an output capacitor 606 at an output terminal, VOUT. Each phase 602A, 602B, 602C, 602D comprises a transformer, such as the transformer 100, having a primary winding 608 and a secondary winding 610, and a switch 612 for selectively coupling the phase 602A, 602B, 602C, 602D the path between the input capacitor 604 and the output capacitor 606. Each switch 612 may include a first switch element 614 connected between the input capacitor 604 and the primary winding 608 and a second switch element 616 connected between the primary winding 608 and a reference voltage terminal, such as ground. The control signals for the switches 612 of the phases 602A, 602B, 602C, 602D may be staggered such that the only one phase 602A, 602B, 602C, 602D is connected at a given time, thereby reducing ripple.

In the TLVR 600, the secondary windings 610 of the phases 602A, 602B, 602C, 602D are connected in series. In some embodiments, a termination inductor 618 is connected between the secondary winding 610 and the reference voltage terminal, such as in the phase 602A (as illustrated) or in the phase 602D. Alternatively, the coupling between the primary windings 608 and the secondary windings 610 may be selected, such as described herein, to provide a desired degree of leakage, thereby obviating the need for the terminating inductor 618. Current flowing through the secondary windings 610 is reflected back into the primary winding 608 of the active phase 602A, 602B, 602C, 602D.

FIGS. 7-12 are diagrams illustrating packages 300 for implementing power stage cooled regulators, in accordance with some embodiments. FIGS. 7-12 include views such as top views, cross-section views, and bottom views illustrating the various embodiments. The TLVR 600 may be implemented in using the packages 300 that integrate the transformer 100 and power stage electronics package, such as the switch 612 in a vertical orientation to provide a power stage cooled configuration. The transformers 100 illustrated in FIGS. 7-12 may be implemented using any of the embodiments of FIGS. 1-6.

Referring to FIG. 7, a diagram of a package 300 including transformers 100A, 100B mounted to a bottom circuit board 302 (e.g., the substrate/circuit board 105), a top circuit board 304 (e.g., the circuit board 110) over the transformers 100A, 100B, a vertical connector circuit board 306 connecting the bottom circuit board 302 and the top circuit board 304, a ground rail 308 connecting the bottom circuit board 302 and the top circuit board 304, and a power stage electronics package 312 (e.g., the package 112) mounted to the top circuit board 304. The power stage electronics package 312 may include multiple semiconductor devices embedded in packaging material. The power stage electronics package 312 may be mounted to the side of the top circuit board 304 opposite to the side that the transformers 100A, 100B are mounted. Discrete circuit elements 314, such as capacitors, resistors, inductors, or other circuit elements, may be mounted to the bottom circuit board 302 or the top circuit board 304. For example, the input capacitor 604 may be mounted to the top circuit board 304 and the output capacitor 602 may be mounted to the bottom circuit board 302. Contacts 315 on the vertical connector circuit board 306 provide paths for voltage rail (VIN, Vcc) or signals exchanged between the bottom circuit board 302 and the top circuit board 304. The contacts 315 may have different sizes. A cooling module may be mounted over the package 300 to cool the power stage electronics package 312 and the transformers 100A, 100B.

The package 300 is a dual phase package including two transformers 100A, 100B with separate cores 106. Each transformer 100A, 100B has its own associated power stage electronics package 312. Each transformer 100 may be associated with a different phase 602A, 602B, 602C, 602D of the TLVR 600. The input current travels from the bottom circuit board 302, through the vertical connector circuit board 306 to the top circuit board 304, and from the top circuit board 304 to the power stage electronics package 312. The output current flows from the power stage electronics package 312 around the top circuit board 304 to the primary winding 102 and from the primary winding 102 to the bottom circuit board. In some embodiments, the bottom circuit board comprises edge plating 316, 317. An electrical connection 318 is provided between the edge plating 317 and one foot 102F of the lower transformer 100 and an electrical connection 320 is provided between the edge plating 316 and one foot 102F of the upper transformer 100. An electrical connection 322 connects the secondary windings 104. In some embodiments, the electrical connection 322 is made in the bottom circuit board 302. The edge plating 316, 317 facilitates connection to other packages 300 for implementing the other phases 602A, 602B, 602C, 602D of the TLVR 600. In some embodiments, the power stage electronics package 312 includes the switch 612, the switch elements 614, 616 and associated gate drivers, and other integrated circuit elements for the TLVR 600, such as temperature, current, or fault reporting circuit elements.

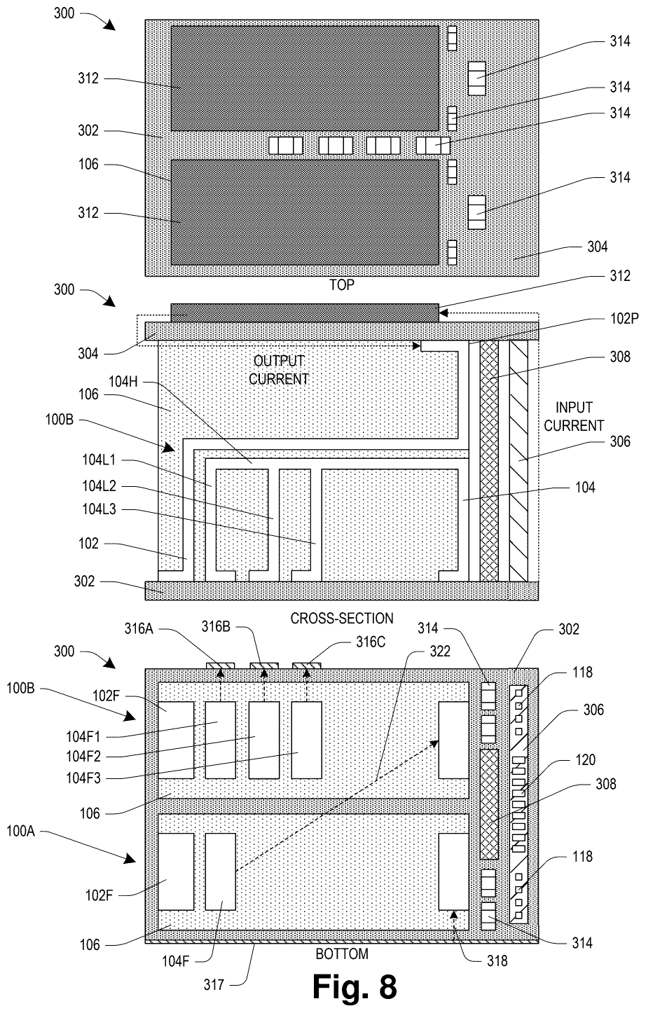

Referring to FIG. 8, the secondary winding 104 of the top transformer 100B includes multiple taps to select the degree of coupling between the primary winding 102 and the secondary winding 104. The secondary winding 104 includes feet 104F1, 104F2, 102F3 each connected by a leg 104L1, 104L2, 104L3 to the horizontal leg 104H at different points of the primary winding 102. The foot 104F1 provides the greatest degree of coupling, the foot 104F2 provides an intermediate degree of coupling, and the foot 102F3 provides the least degree of coupling. The feet 104F1, 104F2, 102F3 may be electrically connected to separate regions of edge plating 316A, 316B, 316C. The secondary winding 104 with multiple taps provides flexibility for the end user, where the degree of coupling can be configured by the user and even change dynamically by selecting the appropriate foot 104F1, 104F2, 104F3.

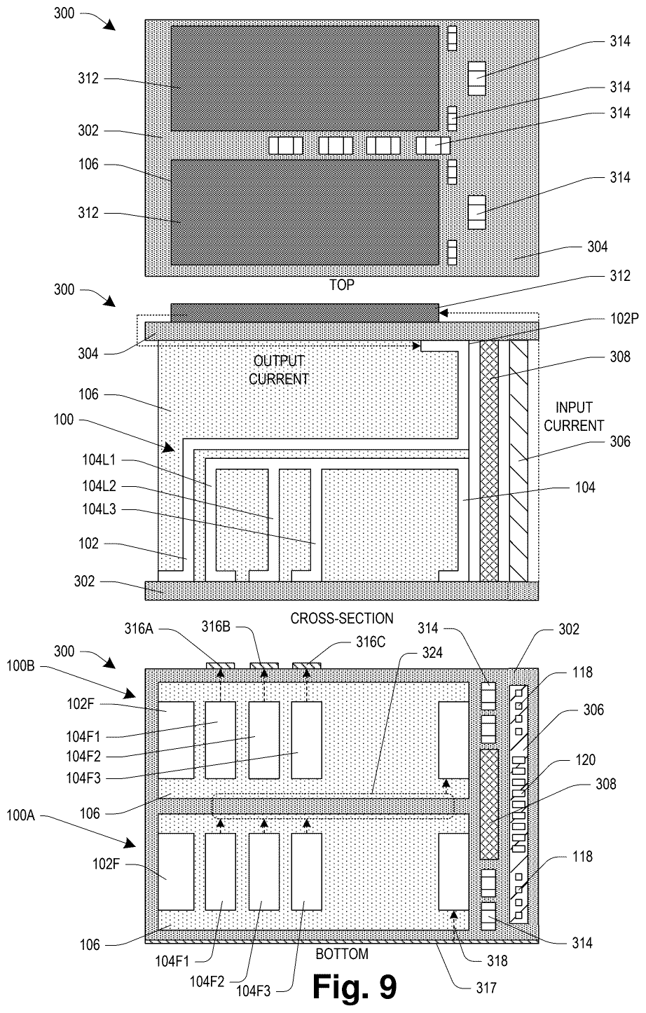

Referring to FIG. 9, the secondary winding 104 of the bottom transformer 100A also includes multiple taps to select the degree of coupling between the primary winding 102 and the secondary winding 104. However, since the feet 104F1, 104F2, 102F3 of the lower transformer 100A are not near the edge plating 316, additional connections 324 would be required in the bottom circuit board 302 to connect the secondary winding 104 of the bottom transformer 100A to the secondary winding 104 of the top transformer 100B.

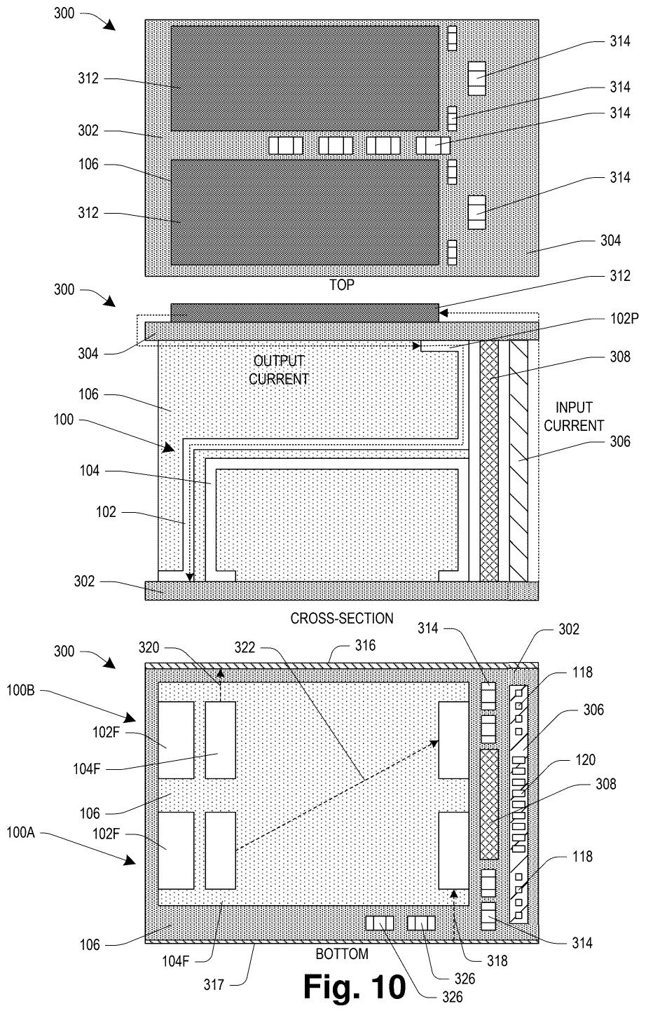

Referring to FIG. 10, the bottom transformer 100A and the top transformer 100B are encapsulated by a common core 106. The core 106 couples the primary winding 102 and the secondary winding of the individual transformers 100A, 100B but does not significantly cross-couple the bottom transformer 100A and the top transformer 100B. If the size of the bottom circuit board 302 is the same as with other embodiments, the use of the single core 106 reduces the footprints of the transformers 100A, 100B, allowing additional discrete elements 326 to be mounted to the bottom circuit board 302. For example, the discrete elements 326 may implement the output capacitor 606. The common core 106 of FIG. 10 may be implemented with other embodiments, such as those shown in FIGS. 7-9, 11, and 12.

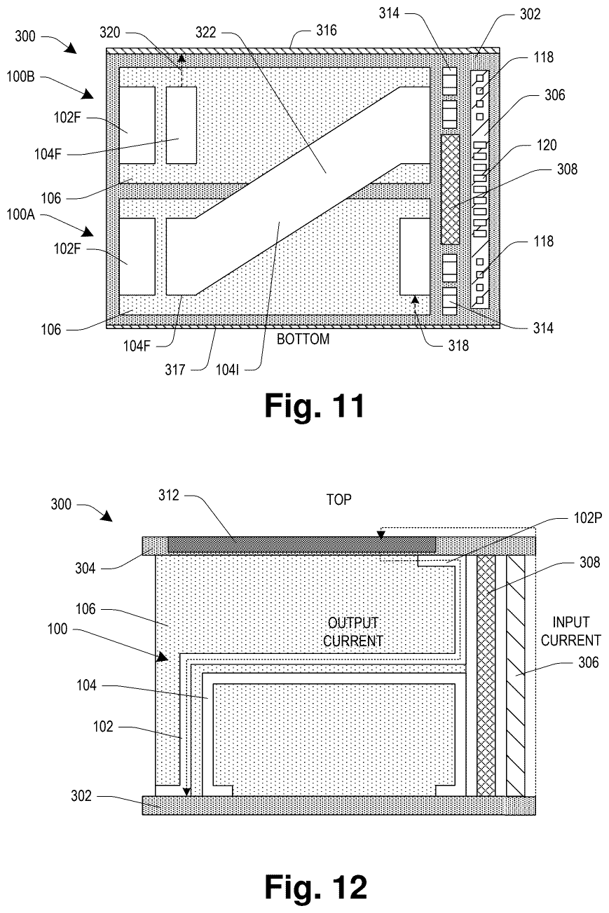

Referring to FIG. 11, the electrical connection 322 between the secondary winding 104 of the bottom transformer 100A and the secondary winding 104 of the top transformer 100B is implemented by an interconnect leg 1041. For example, the secondary winding 104 of the bottom transformer 100A, the secondary winding 104 of the top transformer 100B, and the interconnect leg 1041 may be formed by stamping and bending a single strip of conductive material.

Referring to FIG. 12, the power stage electronics package 312 is at least partially inlaid in the top circuit board 304. The power stage electronics package 312 may be coplanar with the top circuit board 304. Allowing more effective contact between a cooling module and the package 300. In addition, the inlaid arrangement of the power stage electronics package 312 allows the output current to flow through the top circuit board 304 instead of around the top circuit board as illustrated in FIG. 7, thereby reducing losses and noise.

FIG. 13 is a flow diagram illustrating an example method 1300 for fabricating a power stage cooled transformer device, in accordance with some embodiments. At 1302, a first winding 104 is connected to a first circuit board 105. The first winding 104 includes a first foot 104F connected to the first circuit board 105, a first leg 104L extending vertically from the first foot 1004F, a second foot 104F connected to the first circuit board 105, a second leg 1004L extending vertically from the second foot 104F, and a third leg 104H connecting the first leg 104L and the second leg 104L.

At 1304, a second winding 102 is connected to the first circuit board 105. The second winding 102 includes a third foot 102F connected to the first circuit board 105, a fourth leg 102L extending vertically from the third foot 102F, a fifth leg 102H connected to the third leg 102L and extending parallel to the first circuit board 105 to at least partially overlap the third leg 104H, a sixth leg 102V extending vertically from the fifth leg 102H away from the first circuit board 105, and a pad 102P connected to the fourth leg 102V. At 1306, a second circuit board 110 is connected to the pad 102P. At 1307, power stage electronics package 312 comprising a power stage circuit is connected to the second circuit board 110.

According to some embodiments, a transformer comprises a substrate, a first winding comprising a first foot connected to the substrate, a first leg extending vertically from the first foot, a second foot connected to the substrate, a second leg extending vertically from the second foot, and a third leg extending parallel to the substrate to connect the first leg and the second leg, a second winding comprising a third foot connected to the substrate, a fourth leg extending vertically from the third foot, a fifth leg connected to the third leg and extending parallel to the substrate to at least partially overlap the third leg, a sixth leg extending vertically from the fifth leg away from the substrate, and a pad connected to the fourth leg, and a core enclosing at least a portion of the third leg and the fifth leg.

According to some embodiments, the first leg, the second leg and the third leg define a box shape, and the fourth leg, the fifth leg and the sixth leg define a square sigmoid shape.

According to some embodiments, the substrate comprises a circuit board.

According to some embodiments, a first distance between a bottom surface of the core and a bottom surface of the third leg is different than a second distance between a top surface of the core and a top surface of the fifth leg.

According to some embodiments, the first winding comprises a fourth foot connected to the substrate and positioned between the first foot and the second foot, and a seventh leg extending vertically from the fourth foot and connected to the third leg.

According to some embodiments, the first winding comprises a fifth foot connected to the substrate and positioned between the fourth foot and the second foot, and an eighth leg extending vertically from the fifth foot and connected to the third leg.

According to some embodiments, the transformer comprises a third winding comprising a fourth foot connected to the substrate, a seventh leg extending vertically from the fourth foot, a fifth foot connected to the substrate, an eighth leg extending vertically from the second foot, a ninth leg extending parallel to the substrate to connect the seventh leg and the eighth leg, and a tenth leg connecting the fourth foot to the first foot.

According to some embodiments, a voltage regulator comprises a supply voltage terminal, a first circuit board, a first transformer comprising a first secondary winding connected to the first circuit board, a first primary winding comprising a first foot connected to the first circuit board, a first serpentine body connected to the first foot and at least partially overlapping the first secondary winding, and a first contact pad connected to the first serpentine body and vertically offset from a top surface of the first secondary winding in a direction away from the first circuit board, a second transformer comprising a second secondary winding connected to the first circuit board, a second primary winding comprising a second foot connected to the first circuit board, a second serpentine body connected to the second foot and at least partially overlapping the second secondary winding, and a second contact pad connected to the second serpentine body and vertically offset from a top surface of the second secondary winding in a direction away from the first circuit board, a second circuit board contacting the first contact pad and the second contact pad, an interconnect connecting the first secondary winding and the second secondary winding in series, an output terminal connected to the first primary winding and the second primary winding, and a power stage electronics package connected to the second circuit board and comprising a first switch connected between the supply voltage terminal and the first primary winding, and a second switch connected between the supply voltage terminal and the second primary winding.

According to some embodiments, the power stage electronics package is connected to a first side of the second circuit board and the first contact pad and the second contact pad contact a second side of the circuit board opposite the first side.

According to some embodiments, the voltage regulator comprises an input capacitor mounted to the second circuit board and connected to the supply voltage terminal, and an output capacitor mounted to the first circuit board and connected to the output terminal.

According to some embodiments, the voltage regulator comprises a core enclosing at least a portion of the first primary winding, the first secondary winding, the second primary winding, and the second secondary winding.

According to some embodiments, the voltage regulator comprises a first core enclosing at least a portion of the first primary winding and the first secondary winding, and a second core enclosing at least a portion of the second primary winding and the second secondary winding.

According to some embodiments, the interconnect comprises an interconnect leg above the first circuit board and directly connecting the first secondary winding and the second secondary winding.

According to some embodiments, the first secondary winding comprises a first foot connected to the first circuit board, a first leg extending vertically from the first foot, a second foot connected to the first circuit board, a second leg extending vertically from the second foot, and a third leg extending parallel to the first circuit board to connect the first leg and the second leg.

According to some embodiments, the first secondary winding is connected to a first edge plate of the first circuit board, and the second secondary winding is connected to a second edge plate of the first circuit board.

According to some embodiments, the power stage electronics package is inlaid in the second circuit board.

According to some embodiments, a method comprises connecting a first winding to a first circuit board, the first winding comprising a first foot connected to the first circuit board, a first leg extending vertically from the first foot, a second foot connected to the first circuit board, a second leg extending vertically from the second foot, and a third leg connecting the first leg and the second leg, connecting a second winding to the first circuit board, the second winding comprising a third foot connected to the first circuit board, a fourth leg extending vertically from the third foot, a fifth leg connected to the third leg and extending parallel to the first circuit board to at least partially overlap the third leg, a sixth leg extending vertically from the fifth leg away from the first circuit board, and a pad connected to the fourth leg, connecting a second circuit board to the pad, and connecting a die comprises a power stage electronics package to the second circuit board.

According to some embodiments, the method comprises connecting a third circuit board between the first circuit board and the second circuit board.

According to some embodiments, the method comprises connecting at least one of the first foot or the second foot to an edge plate of the first circuit board.

According to some embodiments, the method comprises enabling a connection in the first circuit board to one of the first foot or the third foot.

Various operations of embodiments are provided herein. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Any aspect or design described herein as an “example” and/or the like is not necessarily to be construed as advantageous over other aspects or designs. Rather, use of the word “example” is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

While the subject matter has been described with reference to illustrative embodiments, this description is not intended to be construed in a limiting sense. Various modifications and combinations of the illustrative embodiments, as well as other embodiments of the present disclosure, will be apparent to persons skilled in the art upon reference to the description. It is therefore intended that the appended claims encompass any such modifications or embodiments.

What is claimed is:

1. A transformer, comprising:
a substrate;
a first winding comprising:
a first foot connected to the substrate;
a first leg extending vertically from the first foot;
a second foot connected to the substrate;
a second leg extending vertically from the second foot; and
a third leg extending parallel to the substrate to connect the first leg and the second leg;
a second winding comprising:
a third foot connected to the substrate;
a fourth leg extending vertically from the third foot;
a fifth leg connected to the third leg and extending parallel to the substrate to at least partially overlap the third leg;
a sixth leg extending vertically from the fifth leg away from the substrate; and
a pad connected to the fourth leg; and
a core enclosing at least a portion of the third leg and the fifth leg.

2. The transformer of claim 1, wherein:
the first leg, the second leg and the third leg define a box shape; and
the fourth leg, the fifth leg and the sixth leg define a square sigmoid shape.

3. The transformer of claim 1, wherein:
the substrate comprises a circuit board.

4. The transformer of claim 1, wherein:
a first distance between a bottom surface of the core and a bottom surface of the third leg is different than a second distance between a top surface of the core and a top surface of the fifth leg.

5. The transformer of claim 1, wherein the first winding comprises:
a fourth foot connected to the substrate and positioned between the first foot and the second foot; and
a seventh leg extending vertically from the fourth foot and connected to the third leg.

6. The transformer of claim 5, wherein the first winding comprises:
a fifth foot connected to the substrate and positioned between the fourth foot and the second foot; and
an eighth leg extending vertically from the fifth foot and connected to the third leg.

7. The transformer of claim 1, comprising:
a third winding comprising:
a fourth foot connected to the substrate;
a seventh leg extending vertically from the fourth foot;
a fifth foot connected to the substrate;
an eighth leg extending vertically from the second foot;
a ninth leg extending parallel to the substrate to connect the seventh leg and the eighth leg; and
a tenth leg connecting the fourth foot to the first foot.

8. A voltage regulator, comprising:
a supply voltage terminal;
a first circuit board;
a first transformer comprising:
a first secondary winding connected to the first circuit board;
a first primary winding comprising:
a first foot connected to the first circuit board;
a first serpentine body connected to the first foot and at least partially overlapping the first secondary winding; and
a first contact pad connected to the first serpentine body and vertically offset from a top surface of the first secondary
winding in a direction away from the first circuit board;
a second transformer comprising:
a second secondary winding connected to the first circuit board;
a second primary winding comprising:
a second foot connected to the first circuit board;
a second serpentine body connected to the second foot and at least partially overlapping the second secondary winding; and
a second contact pad connected to the second serpentine body and vertically offset from a top surface of the second secondary winding in a direction away from the first circuit board;
a second circuit board contacting the first contact pad and the second contact pad;
an interconnect connecting the first secondary winding and the second secondary winding in series;
an output terminal connected to the first primary winding and the second primary winding; and
a power stage electronics package connected to the second circuit board and comprising:
a first switch connected between the supply voltage terminal and the first primary winding; and
a second switch connected between the supply voltage terminal and the second primary winding.

9. The voltage regulator of claim 8, wherein:
the power stage electronics package is connected to a first side of the second circuit board and the first contact pad and the second contact pad contact a second side of the circuit board opposite the first side.

10. The voltage regulator of claim 8, comprising:
an input capacitor mounted to the second circuit board and connected to the supply voltage terminal; and
an output capacitor mounted to the first circuit board and connected to the output terminal.

11. The voltage regulator of claim 8, comprising:
a core enclosing at least a portion of the first primary winding, the first secondary winding, the second primary winding, and the second secondary winding.

12. The voltage regulator of claim 8, comprising:
a first core enclosing at least a portion of the first primary winding and the first secondary winding; and
a second core enclosing at least a portion of the second primary winding and the second secondary winding.

13. The voltage regulator of claim 8, wherein:
the interconnect comprises an interconnect leg above the first circuit board and directly connecting the first secondary winding and the second secondary winding.

14. The voltage regulator of claim 8, wherein:
the first secondary winding comprises:
a first foot connected to the first circuit board;
a first leg extending vertically from the first foot;
a second foot connected to the first circuit board;
a second leg extending vertically from the second foot; and
a third leg extending parallel to the first circuit board to connect
the first leg and the second leg.

15. The voltage regulator of claim 8, wherein:
the first secondary winding is connected to a first edge plate of the first circuit board; and
the second secondary winding is connected to a second edge plate of the first circuit board.

16. The voltage regulator of claim 8, wherein:
the power stage electronics package is inlaid in the second circuit board.

17. A method, comprising:
connecting a first winding to a first circuit board, the first winding comprising:
a first foot connected to the first circuit board;
a first leg extending vertically from the first foot;
a second foot connected to the first circuit board;
a second leg extending vertically from the second foot; and
a third leg connecting the first leg and the second leg;
connecting a second winding to the first circuit board, the second winding comprising:
a third foot connected to the first circuit board;
a fourth leg extending vertically from the third foot;
a fifth leg connected to the third leg and extending parallel to the first circuit board to at least partially overlap the third leg;
a sixth leg extending vertically from the fifth leg away from the first circuit board; and
a pad connected to the fourth leg;
connecting a second circuit board to the pad; and
connecting a die comprising a power stage electronics package to the second circuit board.

18. The method of claim 17, comprising:
connecting a third circuit board between the first circuit board and the second circuit board.

19. The method of claim 17, comprising:
connecting at least one of the first foot or the second foot to an edge plate of the first circuit board.

20. The method of claim 17, comprising enabling a connection in the first circuit board to one of the first foot or the third foot.
